(19) United States
(12) Patent Application Publication
(10) Pub. No.: US 2025/0159073 A1
(43) Pub. Date: May 15, 2025

(54) METHOD AND ELECTRONIC DEVICE FOR SINGLE-HANDED OPERATION ASSISTANCE

(71) Applicant: SAMSUNG ELECTRONICS CO., LTD., Suwon-si (KR)

(72) Inventors: Dewanshu HASWANI, Bengaluru (IN); Vijay Narayan TIWARI, Bengaluru (IN); Sumanta BARUAH, Bengaluru (IN); Ankur TRISAL, Bengaluru (IN)

(73) Assignee: SAMSUNG ELECTRONICS CO., LTD., Suwon-si (KR)

(21) Appl. No.: 19/024,553

(22) Filed: Jan. 16, 2025

Related U.S. Application Data
(63) Continuation of application No. PCT/KR2023/012729, filed on Aug. 28, 2023.

(30) Foreign Application Priority Data
Oct. 26, 2022 (IN) 202241060990

(51) Int. Cl. H04M 1/72454; G01S 13/02; H04M 1/72403

(52) U.S. Cl. CPC H04M 1/72454; G01S 13/0209; H04M 1/72403; H04M 2201/42

(57) ABSTRACT

Embodiments herein provide an electronic device and a single-handed operation assistance method for the electronic device. provide single-handed operation assistance method for an electronic device. The method includes detecting, by the electronic device, a single-hand use state of the electronic device. The method includes determining, by the electronic device, a location of a finger of a hand of a user relative to a location of a UI element being displayed on a screen of the electronic device. The method further includes altering, by the electronic device, a location of the at least one UI element to be closer to the finger based on the location of the finger of the hand of the user.

### CROSS-REFERENCES TO RELATED APPLICATIONS

This application is a continuation of International Application No. PCT/KR2023/012729, filed on Aug. 28, 2023, with the Korean Intellectual Property Office, which claims priority from Indian Patent Application No. 202241060990, filed on Oct. 26, 2022, with the Indian Intellectual Property Office, the disclosures of which are incorporated herein by reference in their entireties.

### BACKGROUND

### 1. Technical Field

The present disclosure relates to an electronic device, and more specifically to a method and the electronic device for single-handed operation assistance.

### 2. Related Art

Now-a-days modern electronic devices such as foldable smartphones and tablets have large screens to enhance the viewing experience of a user. Due to the large size of the screen, the user may often struggle while performing a single-handed operation on the screen. In the single-handed operation mode, the user may want to provide inputs to the electronic device while holding the electronic device in one hand. In such scenarios, the user may face difficulty in reaching every corner of the screen while holding the electronic device in one hand.

In order to overcome this challenge, the state-of-the-art electronic device (12) is configured to provide a User Interface (UI) (13) that can be pulled down as shown in (11) of FIG. 1. This enables the user to easily access the UI (13) while holding the electronic device (12) in one hand (14). Alternatively, the electronic device (12) is configured to scale down the UI (13) as shown in (15) of FIG. 1. This enables the user to easily access the UI (13) while holding the electronic device (12) in one hand (14).

However, when the UI is pulled down as shown in (11) of FIG. 1, one or more UI elements in the UI go out of view, which ultimately affects the viewing experience for the user. Alternately, when the UI is scaled down as shown in (15) of FIG. 1, the UI elements become smaller, and hence the user may face difficulty in clearly locating and/or identifying the UI elements. Furthermore, manual input is required for enabling/disabling the single-handed operation mode on the electronic device. This can be very cumbersome for the user, as the user may prefer seamless and automated operations. This leads to limited usage of the state-of-the-art single-handed operation modes in electronic devices. Thus, there seems to be a need for a novel method of enabling a single-handed operation mode that is both user-friendly and that enriches the user experience.

### SUMMARY

Accordingly, the embodiments herein provide single-handed operation assistance method for an electronic device. The method includes detecting, by the electronic device, a single-hand use state of the electronic device. The method includes determining, by the electronic device, a location of a finger of a hand of a user relative to a location of a UI element being displayed on a screen of the electronic device. The method further includes altering, by the electronic device, a location of the at least one UI element to be closer to the finger based on the location of the finger of the hand of the user.

In an embodiment, the single-hand use state of the electronic device is detected using a UWB sensor of the electronic device.

In an embodiment, the method comprises automatically activating a single-handed operation mode based on detecting the single-hand use state of the electronic device.

In an embodiment, the electronic device determines the location of the finger of the hand relative to the location of the UI element being displayed on the screen of the electronic device, by receiving a UWB signal reflected from the finger; estimating, by the electronic device, a type of the hand by providing the UWB signal to an AI model; determining, by the electronic device, a direction of the finger pointing towards the UI element based on the UWB signal and the type of the hand; identifying, by the electronic device, the UI element being displayed on the screen based on the direction of the finger; and determining, by the electronic device, the location of the finger of the hand relative to the location of the identified UI element.

In an embodiment, the electronic device determines the direction of the finger pointing towards the UI element based on the UWB signal and the type of the hand by determining, the permittivity of one or more parts of the finger based on the UWB signal; identifying, by the electronic device, the one or more parts of the finger based on the permittivity; determining, by the electronic device, proximity between the one or more parts of the finger based on the permittivity; determining, by the electronic device, a projection of the finger relative to the electronic device based on the UWB signal; and determining, by the electronic device, the direction of the finger pointing towards the UI element based on the one or more parts of the finger, the proximity between the one or more parts of the finger, and the projection of the finger.

In an embodiment, the electronic device further alters the location of the UI element such that the UI element is closer to the finger after the alteration, by determining a location on the screen closer to the finger based on the location of the finger; and altering, by the electronic device, the location of the UI element to the determined location on the screen.

Accordingly, the embodiments herein provide the electronic device the single-handed operation assistance method. The electronic device includes a single-hand mode assistance engine, memory, at least one processor, the UWB sensor, and a screen, where the single-hand mode assistance engine is coupled to the memory and the at least one processor. The single-hand mode assistance engine is configured to detect the single-hand use state of the electronic device. The single-hand mode assistance engine is configured to determine the location of the finger of the hand relative to the location of the UI element being displayed on the screen of the electronic device. The single-hand mode assistance engine is configured to alter a location of the at least one UI element to be closer to the finger after the alteration based on the location of the finger of the hand of the user.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments, and the embodiments herein include all such modifications.

### BRIEF DESCRIPTION OF THE DRAWINGS

This disclosure is illustrated in the accompanying drawings, throughout which reference letters indicate corresponding parts in the various figures. The embodiments herein will be better understood from the following description with reference to the drawings, in which:

FIG. 1 illustrates related methods for providing single-handed operation assistance to a user, according to related arts;

FIG. 2 is a block diagram of an electronic device for providing the single-handed operation assistance to the user, according to an embodiment as disclosed herein;

FIG. 3 is a flow diagram illustrating a process for providing the single-handed operation assistance to the user, according to an embodiment as disclosed herein;

FIG. 4 illustrates a pointer displayed on the screen based on a direction indicated by a finger, according to an embodiment as disclosed herein;

FIGS. 5A and 5B illustrates example scenarios of selecting a UI element and moving the UI element closer to the finger, according to an embodiment as disclosed herein;

FIG. 6 is a flow diagram illustrating a process for moving the UI element closer to the finger by determining the direction indicated by the finger, according to an embodiment as disclosed herein;

FIG. 7 is a schematic diagram illustrating the transmission and reception of UWB signals by a UWB sensor, according to an embodiment as disclosed herein;

FIG. 8A is a graph illustrating a dielectric constant of one or more parts of a human body determined at various frequencies of a UWB signal, according to an embodiment as disclosed herein;

FIG. 8B illustrates a schematic diagram of the placement of the finger with respect to planes defined by the UWB sensor for determining the direction indicated by the finger, according to an embodiment as disclosed herein;

FIG. 9 is a flow diagram illustrating a method of reconstructing an outline of the finger, according to an embodiment as disclosed herein;

FIGS. 10A-10B illustrate thickness of the one or more parts of the finger determined by the electronic device, according to an embodiment as disclosed herein; and

FIGS. 11-14 illustrate example scenarios of providing the single-handed operation assistance to the user, according to an embodiment as disclosed herein.

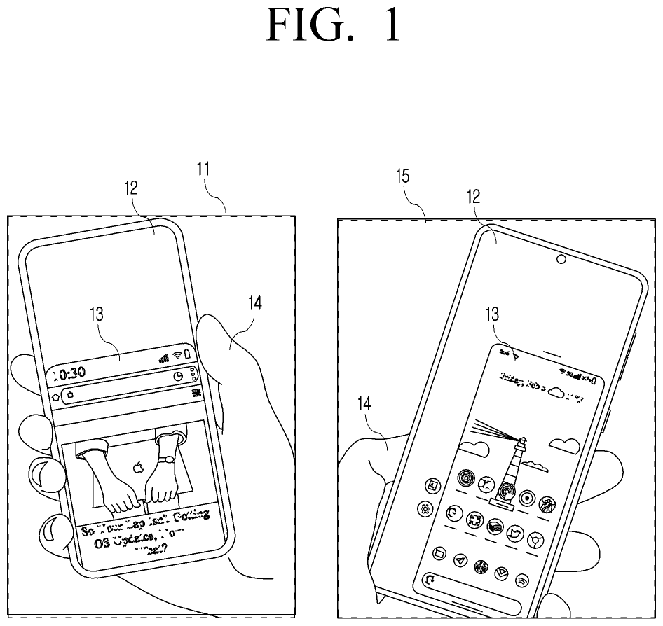

### DETAILED DESCRIPTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

As in related art, embodiments may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by firmware. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings.

One or more embodiments provide a method and an electronic device for single-handed operation assistance. The electronic device detects a direction of a finger (e.g. thumb) of a hand of a user pointing towards a UI element displayed on a screen of the electronic device using an Ultra-Wide Band (UWB) sensor during a single-handed operation mode. Further, the electronic device automatically brings the UI element closer to the finger to enable the user to easily access/interact with the UI element. The method further allows the user to reach every corner of the screen in a full-screen mode without minimizing the screen or scaling down and/or pulling down a UI of the electronic device, which improves the user experience.

Accordingly, the embodiments herein provide a single-handed operation assistance method for an electronic device. The method includes detecting, by the electronic device, a single-hand use state of the electronic device. The method includes determining, by the electronic device, a location of a finger of a hand of a user relative to a location of a UI element being displayed on a screen of the electronic device. The method includes altering, by the electronic device, the location of the UI element such that the UI element is closer to the finger after the alteration.

Accordingly, the embodiments herein provide the electronic device with the single-handed operation assistance method. The electronic device includes a single-hand mode assistance engine, a memory, a processor, a UWB sensor, and the screen, where the single-hand mode assistance engine is coupled to the memory and the processor. The single-hand mode assistance engine is configured to detect the single-hand use state of the electronic device. The single-hand mode assistance engine is configured to determine the location of the finger of the hand of the user relative to the location of the UI element being displayed on the screen of the electronic device. The single-hand mode assistance engine is configured for altering the location of the UI element such that the UI element is closer to the finger after the alteration.

Unlike existing methods and systems, the electronic device detects a direction of the finger (e.g., thumb) of the hand of the user pointing towards the UI element displayed on the screen of the electronic device using the UWB sensor during the single-handed operation mode. Further, the electronic device automatically brings the UI element closer to the location of the finger to enable the user to easily access/interact with the UI element. The method further allows the user to reach every corner of the screen in a full-screen mode without minimizing the screen or scaling down and/or pulling down a UI of the electronic device, which improves the user experience.

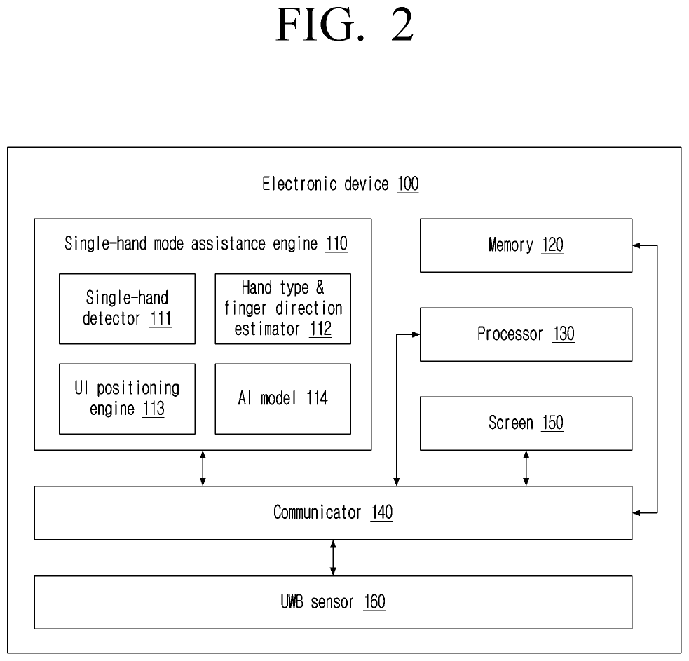

Referring now to the drawings, and more particularly to FIGS. 2 through 14, there are shown preferred embodiments.

FIG. 2 is a block diagram of an electronic device (100) for providing a single-handed operation assistance to a user, according to an embodiment as disclosed herein. Examples of the electronic device (100) include, but are not limited to a smartphone, a tablet computer, a Personal Digital Assistance (PDA), a foldable phone, etc. In an embodiment, the electronic device (100) includes a single-hand mode assistance engine (110), a memory (120), a processor (130), a communicator (140), a screen (150), and an Ultra-Wideband (UWB) sensor (160), where the screen (150) is a physical hardware component that can be used to display a User Interface (UI) to a user. Examples of the screen (150) include, but are not limited to a light-emitting diode display, a liquid crystal display, etc. The single-hand mode assistance engine (110) is implemented by processing circuitry such as logic gates, integrated circuits, microprocessors, microcontrollers, memory circuits, passive electronic components, active electronic components, optical components, hardwired circuits, or the like, and may optionally be driven by a firmware. The circuits may, for example, be embodied in one or more semiconductor chips, or on substrate supports such as printed circuit boards and the like.

In an embodiment, the single-hand mode assistance engine (110) includes a single-hand detector (111), a hand type & finger direction estimator (112), a UI positioning engine (113), and an Artificial Intelligence (AI) model (114). The single-hand detector (111), the hand type & finger direction estimator (112), the UI positioning engine (113), and the Artificial Intelligence (AI) model (114) are implemented by processing circuitry such as logic gates, integrated circuits, microprocessors, microcontrollers, memory circuits, passive electronic components, active electronic components, optical components, hardwired circuits, or the like, and may optionally be driven by a firmware. The circuits may, for example, be embodied in one or more semiconductor chips, or on substrate supports such as printed circuit boards and the like.

The single-hand detector (111) detects a single-hand use state of the electronic device (100). In an embodiment, the single-hand use state of the electronic device (100) is detected using the UWB sensor (160). The UWB sensor (160) transmits a UWB signal which hits on the hand of the user that holds the electronic device (100). The UWB signal is the reflected back to the UWB sensor (160). Thus, the UWB sensor (160) receives the reflected UWB signal. The single-hand detector (111) automatically activates a single-handed operation mode in response to detecting the single-hand use state of the electronic device (100). The hand type & finger direction estimator (112) determines the location of the finger of the hand relative to the location of the UI element being displayed on the screen (150). The UI positioning engine (113) alters the location of the UI element such that the UI element is closer to the finger after the alteration.

In an embodiment, for determining the location of the finger of the hand of the user relative to the location of the UI element, the single-hand detector (111) receives the UWB signal reflected from the finger. In response to receiving the UWB signal, the single-hand detector (111) and pre-processes the received UWB signal and forwards the pre-processed UWB signal to the hand type & finger direction estimator (112). The hand type & finger direction estimator (112) estimates a type of the hand (i.e. left hand or right hand) by providing the pre-processed UWB signal to the AI model (114). The hand type & finger direction estimator (112) determines the direction of the finger pointing towards the UI element based on the UWB signal and the type of the hand. The hand type & finger direction estimator (112) identifies the UI element being displayed on the screen (150) based on the direction of the finger. The hand type & finger direction estimator (112) determines the location of the finger of the hand relative to the location of the identified UI element.

In an embodiment, for determining the direction of the finger pointing towards the UI element based on the UWB signal and the type of the hand, the hand type & finger direction estimator (112) determines permittivity (i.e., dielectric constant) of one or more parts of the finger based on the UWB signal. The hand type & finger direction estimator (112) identifies one or more parts of the finger based on the determined permittivity. The hand type & finger direction estimator (112) further determines a proximity between the one or more parts of the finger based on the determined permittivity. The hand type & finger direction estimator (112) determines a projection of the finger relative to the location of the electronic device (100) based on the UWB signal. The hand type & finger direction estimator (112) further determines the direction of the finger pointing towards the UI element based on one or more parts of the finger, the proximity between one or more parts of the finger, and the projection of the finger.

In an embodiment, the UI positioning engine (113) determines a location on the screen (150) closer to the finger based on the location of the finger. The UI positioning engine (113) alters the location of the UI element to the determined location on the screen (150).

The single-hand mode assistance engine (110) recognizes the location of the finger, i.e. an angle of projection of a nail by determining the permittivity (i.e., dielectric constant) for various parts of the finger from the reflected UWB signals, reconstructing the structure of the finger based on the determined permittivity of the various parts, and identifying the positioning of the nail of the finger based on the determined permittivity of the nail, where the fingernail has different permittivity compared to other soft tissues of the finger and the bone. Further, the single-hand mode assistance engine (110) uses the determined location of the fingernail as a benchmark to render a pointer for a selection of the UI element.

The memory (120) stores instructions to be executed by the processor (130). The memory (120) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (120) may, in some examples, be considered a non-transitory storage medium. The term “non-transitory” may indicate that the storage medium is not embodied in a carrier wave or a propagated signal. However, the term “non-transitory” should not be interpreted that the memory (120) is non-movable. In some examples, the memory (120) can be configured to store larger amounts of information than its storage space. In certain examples, a non-transitory storage medium may store data that can, over time, change (e.g., in Random Access Memory (RAM) or cache). The memory (120) can be an internal storage unit or it can be an external storage unit of the electronic device (100), cloud storage, or any other type of external storage.

The processor (130) is configured to execute instructions stored in the memory (120). The processor (130) may be a general-purpose processor, such as a Central Processing Unit (CPU), an Application Processor (AP), or the like, a graphics-only processing unit such as a Graphics Processing Unit (GPU), a Visual Processing Unit (VPU) and the like. The processor (130) may include multiple cores to execute the instructions. The communicator (140) is configured for communicating internally between hardware components in the electronic device (100). Further, the communicator (140) is configured to facilitate communication between the electronic device (100) and other devices via one or more networks (e.g. Radio technology). The communicator (140) includes an electronic circuit specific to a standard that enables wired or wireless communication.

A function associated with the AI model (114) may be performed through the non-volatile/volatile memory (120), and the processor (130). One or more processors (130) control the processing of the input data in accordance with a predefined operating rule or the AI model (114) stored in the non-volatile/volatile memory (120). The predefined operating rule or the AI model (114) is provided through training or learning. Here, being provided through learning means that, by applying a learning method to a plurality of learning data, the predefined operating rule or the AI model (114) using desired characteristic is made. The learning may be performed in the electronic device (100) itself in which the AI model (114) according to an embodiment is performed, and/or may be implemented through a separate server/system. The AI model (114) may consist of a plurality of neural network layers. Each layer has a plurality of weight values, and performs a layer operation through the calculation of a previous layer and an operation of a plurality of weights. Examples of neural networks include, but are not limited to, convolutional neural network (CNN), deep neural network (DNN), recurrent neural network (RNN), restricted Boltzmann Machine (RBM), deep belief network (DBN), bidirectional recurrent deep neural network (BRDNN), generative adversarial networks (GAN), and deep Q-networks. The learning method is a method for training a predetermined target device (for example, a robot) using a plurality of learning data to cause, allow, or control the target device to make a determination or prediction. Examples of the learning method include, but are not limited to, supervised learning, unsupervised learning, semi-supervised learning, or reinforcement learning.

Although FIG. 2 shows the hardware components of the electronic device (100), it is to be understood that other embodiments are not limited thereon. In other embodiments, the electronic device (100) may include less or more components. Further, the labels or names of the components are used only for illustrative purpose and does not limit the scope of the disclosure. One or more components can be combined to perform the same or substantially similar function for providing single-handed operation assistance to the user.

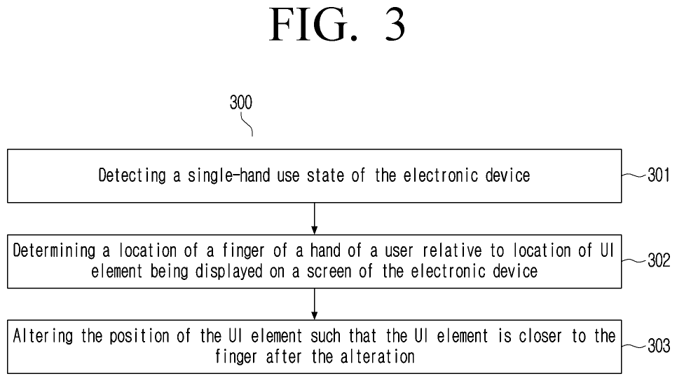

FIG. 3 is a flow diagram (300) illustrating a method for providing single-handed operation assistance to the user, according to an embodiment as disclosed herein. In an embodiment, the method allows the single-hand mode assistance engine (110) to perform operations 301-303 of the flow diagram (300). At operation 301, the method includes detecting the single-hand use state of the electronic device (100). At operation 302, the method includes determining the location of the finger of the hand of the user relative to the location of the UI element being displayed on the screen (150). At operation 303, the method includes altering the location of the UI element such that the location of the UI element is closer to the finger after the alteration.

The various actions, acts, blocks, steps, operations, or the like in the flow diagram (300) may be performed in the order presented, in a different order than presented, or simultaneously. Further, in some embodiments, some of the actions, acts, blocks, steps, operations, or the like may be omitted, added, modified, skipped, or the like without departing from the scope of the disclosure.

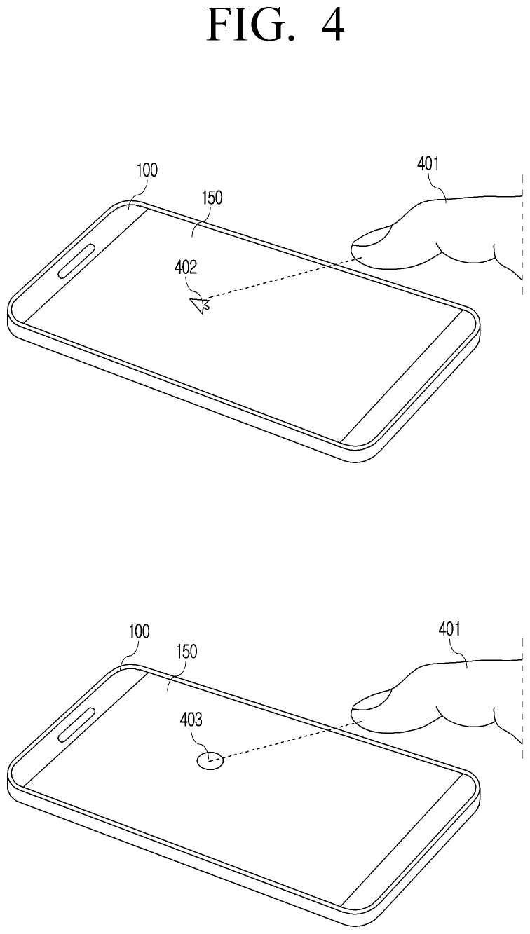

FIG. 4 illustrates the pointer displayed on the screen (150) based on the direction indicated by the finger, according to an embodiment as disclosed herein. Upon pointing the finger (401) towards a UI element on the screen (150) of the electronic device (100), the electronic device (100) determines the direction indicated by the finger (401) using the UWB sensor (160), an initial location of the pointer based on the determined direction, and displays the pointer such as a mouse pointer (402), a stylus pointer (403), etc. on the screen (150).

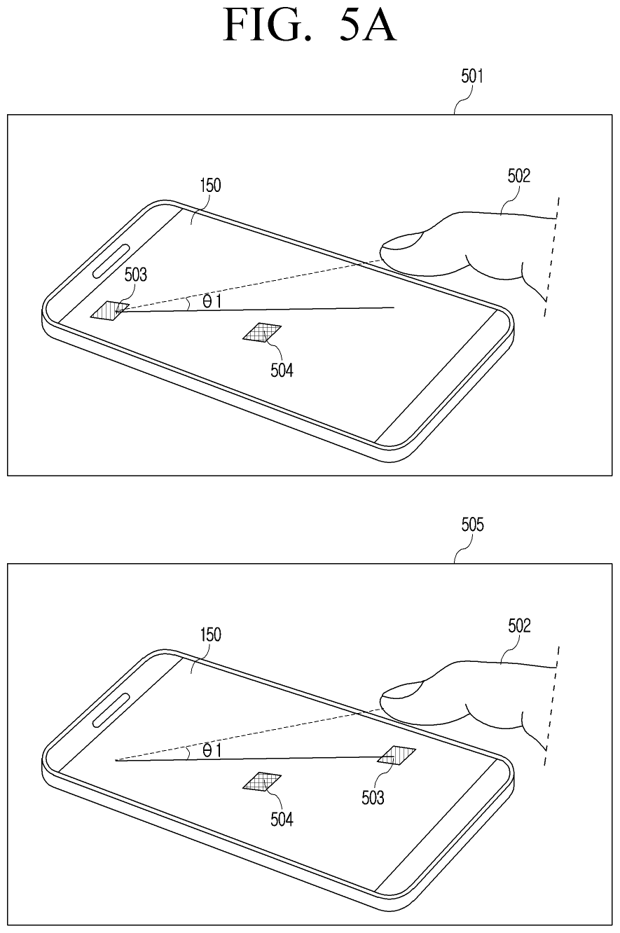

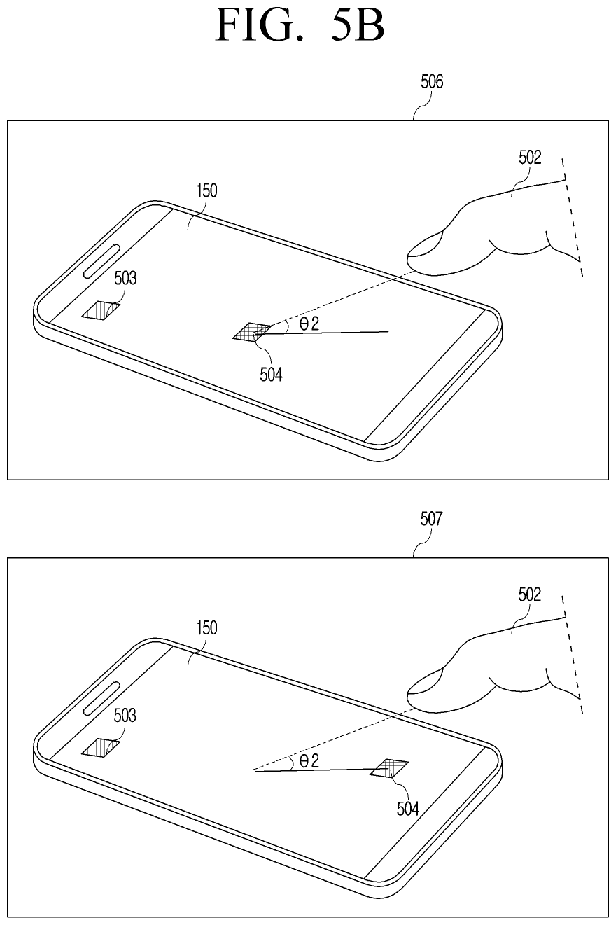

FIGS. 5A and 5B illustrates example scenarios of selecting the UI element and moving the UI element closer to the finger, according to an embodiment as disclosed herein. Consider, the electronic device (100) is displaying two UI elements (503, 504), and the finger (502) is pointing towards the UI element (503) displayed on the screen (150) of the electronic device (100) as shown in 501. Further, the electronic device (100) determines the direction (01) as indicated by the finger (401) using the UWB sensor (160), the initial location of the pointer based on the determined direction (01), and locates the pointer on the UI element (503).

The direction (01) indicated by the finger (401) is fed to a track pointer movement of an operating system framework, where the location of the pointer on the screen (150) is further controlled by the electronic device (100) using an Application Programming Interface (API) of the operating system framework based on a change in the direction (01) indicated by the finger (401). The electronic device (100) selects the UI element (503) upon locating the pointer on the UI element (503) for a time duration (e.g., 1 second). The electronic device (100) changes the pointer location with the user pointing towards different locations on the screen (150), i.e. the pointer follows the user's finger-pointing direction which is determined by establishing the permittivity of the fingernail. Alternatively, the electronic device (100) identifies the location in the screen (150) nearest to the finger (401) and moves the UI element (503) at the identified nearest location as shown in 505.

Consider, the finger (502) is pointing towards the UI element (504) displayed on the screen (150) of the electronic device (100) as shown in 506. Further, the electronic device (100) determines the direction (02) indicated by the finger (401) using the UWB sensor (160), the initial location of the pointer based on the determined direction (02) and locates the pointer on the UI element (504). The direction (02) indicated by the finger (401) is fed to the track pointer movement of the operating system framework, where the location of the pointer on the screen (150) is further controlled by the electronic device (100) using the API of the operating system framework based on the change in the direction (02) indicated by the finger (401).

The electronic device (100) selects the UI element (504) upon locating the pointer on the UI element (503) for the time duration. The electronic device (100) changes the pointer location with the user pointing towards different locations on the screen (150), i.e. the pointer follows the user's finger-pointing direction which is determined by establishing the permittivity of the fingernail. Alternatively, the electronic device (100) identifies the location in the screen (150) nearest to the finger (401) and moves the UI element (504) towards the nearest location as shown in 507.

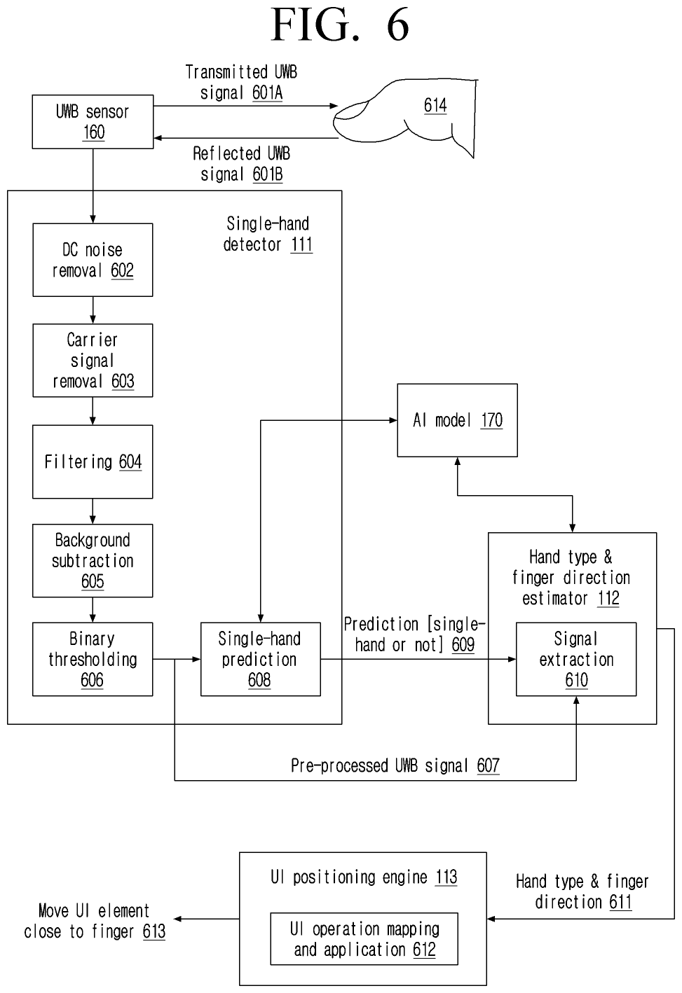

FIG. 6 is a flow diagram illustrating a method of moving the UI element closer to the finger by determining the direction indicated by the finger, according to an embodiment as disclosed herein. Consider, the user is pointing towards the UI element displayed on the screen (150) using the finger (614). The UWB sensor (160) transmits the UWB signal (601A), and further the transmitted UWB signal (601A) hits the finger (614). The UWB sensor (160) receives the UWB signal (601B) reflected from the finger (614) and transfers the UWB signal (601B) to the single-hand detector (111). The single-hand detector (111) performs pre-processing of the reflected UWB signal (601B), which includes DC noise removal (602), carrier signal removal (603), filtering (604), background subtraction (605), and binary thresholding (606) of the reflected UWB signal (601B). The single-hand detector (111) predicts whether the electronic device (100) is held by the user for performing the single-hand operation using the AI model (170). Further, the single-hand detector (111) provides the prediction result (609) and the pre-processed UWB signal (607) to the hand type & finger direction estimator (112).

The hand type & finger direction estimator (112) extracts real and imaginary parts of the pre-processed UWB signal and generates a spectrogram using the real and imaginary parts. Further, the hand type & finger direction estimator (112) provides the spectrogram to the AI model (170), where the AI model (170) is trained on the signal spectrograms to infer/predict the hand type [(left hand or right hand) and the finger direction (i.e. the direction of the finger (614)). Upon receiving the prediction on the hand type and the finger direction from the AI model (170), the hand type & finger direction estimator (112) provides the hand type and the finger direction to the UI positioning engine (113). Further, the UI positioning engine (113) performs UI operation mapping and application (612) and moves the UI element close to the finger (613).

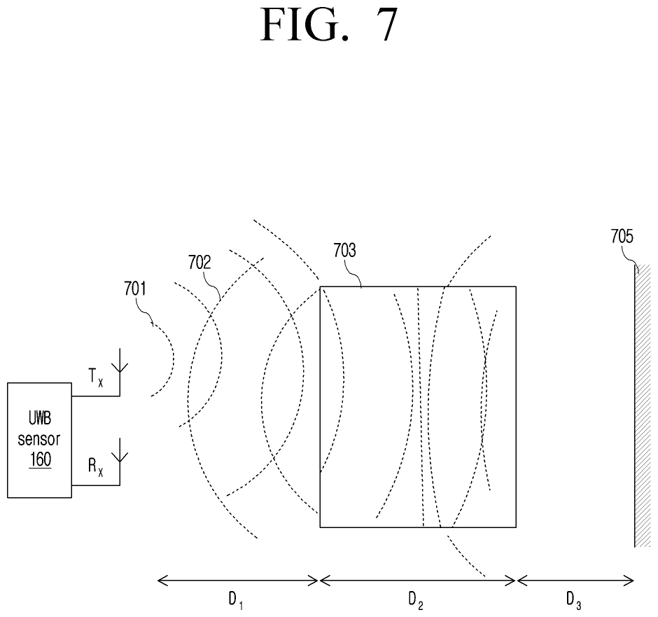

FIG. 7 is a schematic diagram illustrating the transmission and reception of the UWB signals by the UWB sensor (160), according to an embodiment as disclosed herein. As shown in FIG. 7, the UWB sensor (160) transmits the UWB signal (701), and the transmitted UWB signal (701) hits on the finger (703). The UWB sensor (160) receives the UWB signal (702) reflected from the finger (703). The electronic device (100) pre-processes the reflected UWB signal (702) and estimates the dielectric constants of the parts of the finger (703) from the pre-processed UWB signal using the equation given below:

$$Dielectric Constant ε ≅ {[ 1 + Δ T / ( d / c ) ]}^{2} \qquad Eqn ( 1 )$$

where d is the thickness of each part of the finger (701), c is the speed of light in free space, ΔT is the difference of time between 2 consecutive reflected UWB signals, where d=c*T². Using the pre-processed UWB signal, the electronic device (100) determines ΔT and the thickness of a particular tissue (e.g. fingernail) i.e. a part of the finger. The electronic device (100) provides the estimated dielectric constant of a particular tissue as an input to the AI model (114) to identify that particular tissue.

$${D}_{1} = {c}_{0} {T}_{1}^{2} , \qquad Eqn ( 2 )$$

$${D}_{2} = {{c}_{0} ( T r - {T}_{1} + {T}_{2} - {T}_{3} )}^{2} \qquad Eqn ( 3 )$$

$$D 3 = {c}_{0} ( T 3 - T 2 ) 2 \qquad Eqn ( 4 )$$

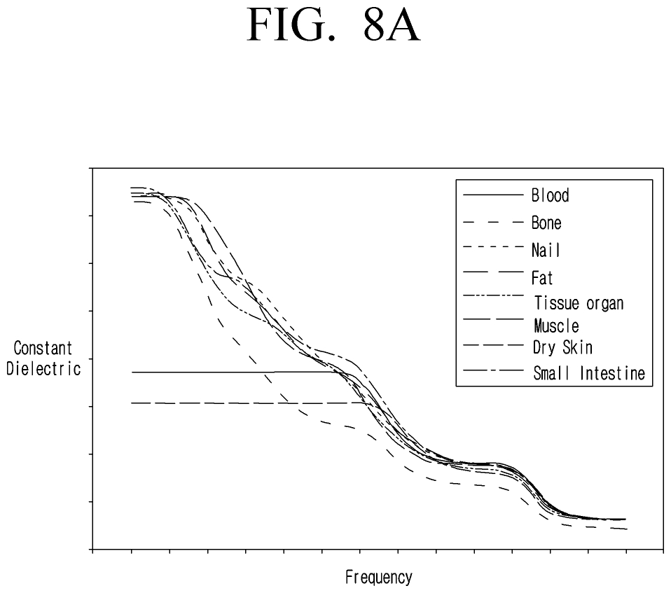

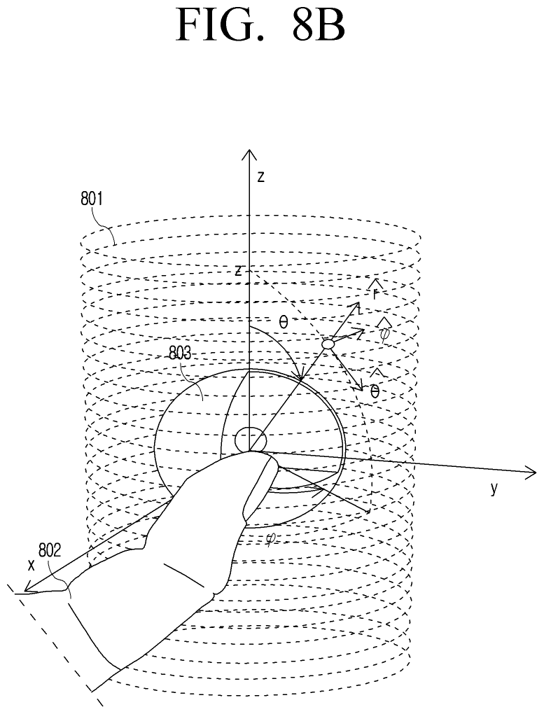

FIG. 8A is a graph illustrating the dielectric constants of parts of the human body determined at various frequencies of the UWB signal, according to an embodiment as disclosed herein. The AI model (114) contains the relation of the dielectric constant of various parts of the human body including blood, bone, nail, fat, tissue organ, muscle, dry skin, small intestine, etc. at various frequencies of the UWB signal as shown in the FIG. 8A.

FIG. 8B illustrates a schematic diagram of the placement of the finger with respect to planes defined by the UWB sensor (160) for determining the direction indicated by the finger, according to an embodiment as disclosed herein. Permittivity (i.e. dielectric constant) varies for different body tissues. Using the UWB signals, the electronic device (100) estimates the permittivity of each finger tissue (i.e. finger part), and proximity related to that finger part, i.e. d(x,y). Further, the electronic device (100) identifies the finger parts (including nails) using the permittivity (ε) using the relation of the dielectric constant of various parts of the human body in the AI model (114). Further, the electronic device (100) determines an angle of projection (θ) of the finger over the electronic device (100) or the screen (150) using multi-channel sensors or with the UWB sensor (160) alone. Further, the electronic device (100) reconstructs and localizes the finger projection by using a three-dimensional cylindrical tomographic formulation based on the identified finger parts, proximity related to the finger parts, and the angle of projection (θ).

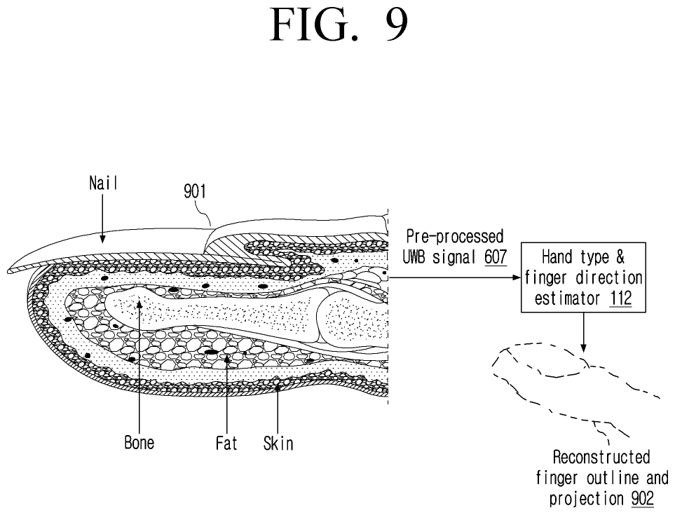

FIG. 9 is a flow diagram illustrating a method of reconstructing the outline of the finger, according to an embodiment as disclosed herein. A side view of a cross-section of the finger is shown in 901. The finger parts include the nail, the bone, the fat, and the skin. The UWB sensor (160) receives the UWB signal (601B) reflected from the finger parts and forwards to the single-hand detector (111). Further, the hand type & finger direction estimator (112) receives the pre-processed UWB signal (607) from the single-hand detector (111) and reconstructs the finger outline and projection (902). The thickness of the finger tissues (including the nail) varies across different angles of the UWB signals. Variation in the finger tissue thickness can be calculated from the reflected UWB signals and is used by the electronic device (100) to reconstruct finger projection which will be used to identify the location of the fingernail.

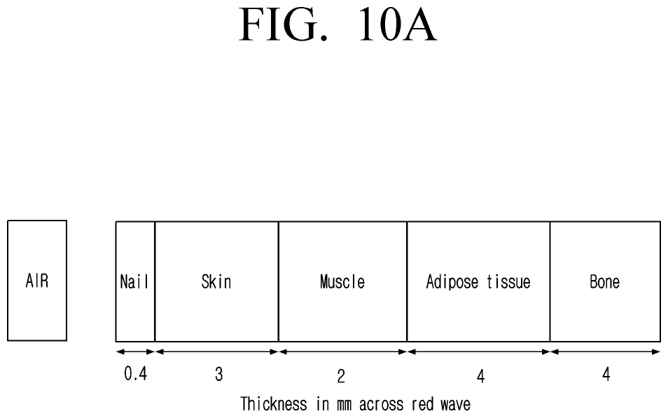

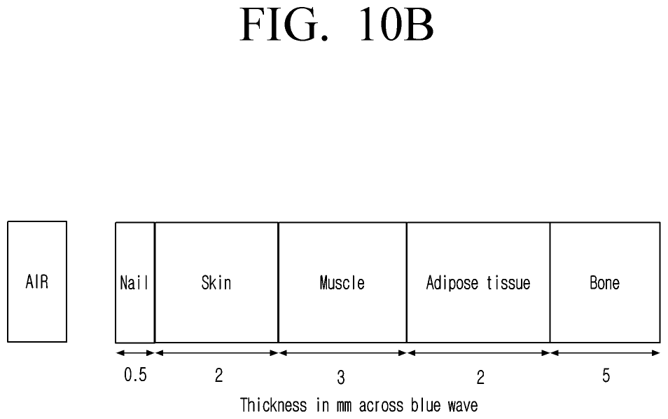

FIGS. 10A-10B illustrate thickness of the one or more parts of the finger determined by the electronic device (100), according to an embodiment as disclosed herein. As shown in FIG. 10A, in an example scenario the electronic device (100) determines the thickness of the nail, the skin, the muscle, the adipose tissue, and the bone as 0.4 millimeters (mm), 3 mm, 2 mm, 4 mm, and 4 mm respectively. As shown in FIG. 10B, in another example scenario the electronic device (100) determines the thickness of the nail, the skin, the muscle, the adipose tissue, and the bone as 0.5 mm, 2 mm, 3 mm, 2 mm, and 5 mm respectively.

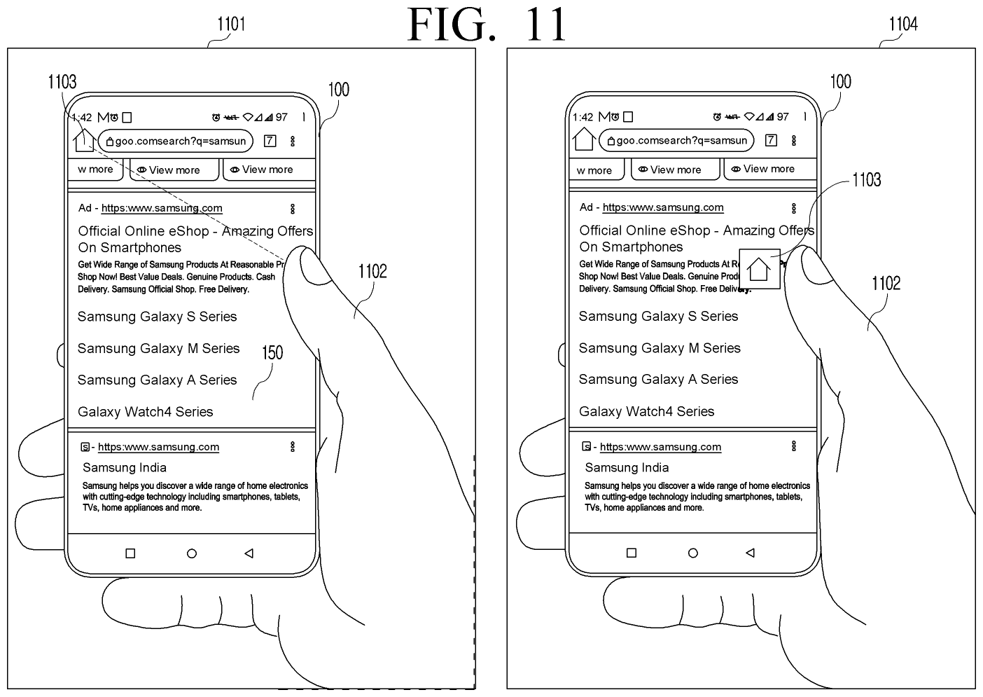

FIGS. 11-14 illustrate example scenarios of providing the single-handed operation assistance to the user, according to an embodiment as disclosed herein. As shown in the FIG. 11, in an example scenario, consider the user is holding the electronic device (100) on the hand for performing the single-hand operation on a website opened in a browser application at 1101. The thumb (1102) is pointing towards the direction of a home icon (1103) of the website. The electronic device (100) identifies that the user wants to perform the single-hand operation based on the UWB signal reflected from the hand. Further, the electronic device (100) determines the hand type, and the pointing direction of the thumb (1102). Further, the electronic device (100) identifies that the thumb (1102) is pointing towards the home icon (1103) based on the determined direction. Further, the electronic device (100) determines the location on the screen (150) closer to the thumb (1102). At 1104, the electronic device (100) moves the home icon (1103) closer to the thumb (1102) for ease of operation of the user.

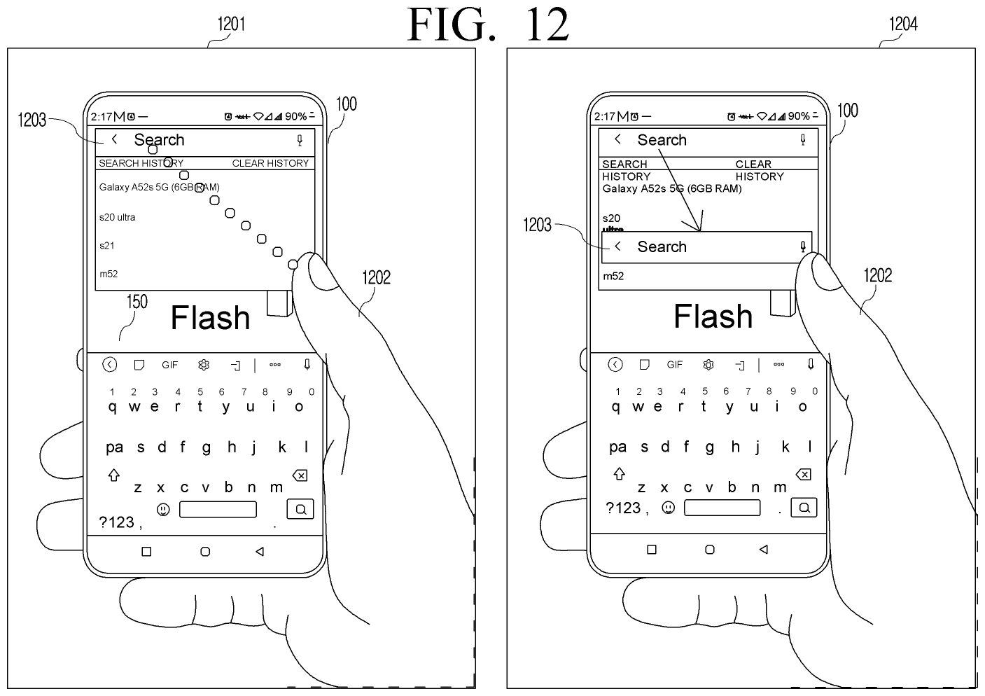

As shown in the FIG. 12, in another example scenario, consider the user is holding the electronic device (100) in the hand for performing the single-hand operation on a search bar (1203) opened in a setting application at 1201. The thumb (1202) is pointing towards the direction of a search bar (1203). The electronic device (100) identifies that the user wants to perform the single-hand operation based on the UWB signal reflected from the hand. Further, the electronic device (100) determines the hand type, and the pointing direction of the thumb (1202). Further, the electronic device (100) identifies that the thumb (1202) is pointing towards the search bar (1203) based on the determined direction. Further, the electronic device (100) determines the location on the screen (150) closer to the thumb (1202). At 1204, the electronic device (100) relocates the search bar (1203) closer to the thumb (1202) for ease of operation of the user.

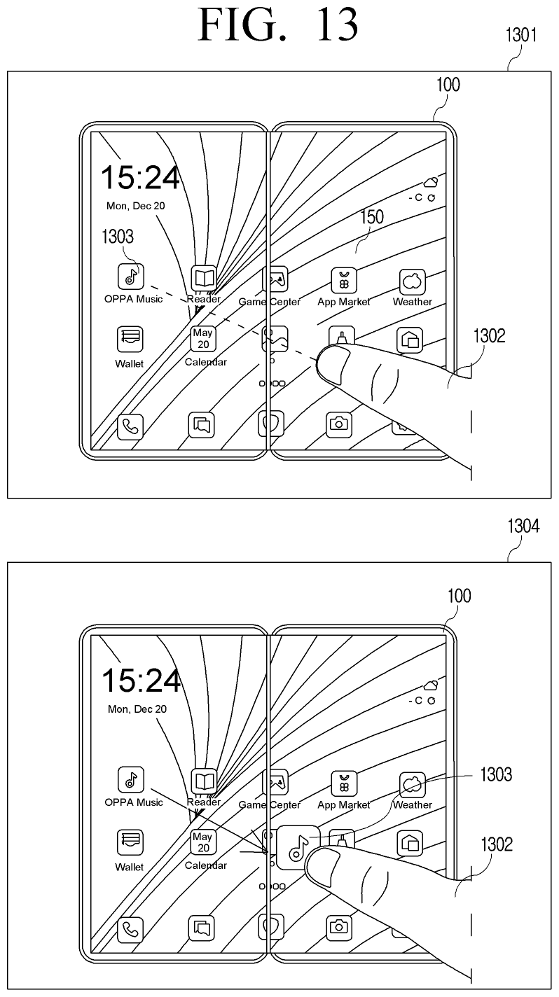

As shown in the FIG. 13, in another example scenario, consider the user is holding the electronic device (100) (e.g. a foldable smartphone) on one hand at 1301. The user wants to open a music application using a thumb (1302) while holding the electronic device (100) on the one hand, whereas a music application icon (1303) is away from the thumb (1302). The thumb (1302) is pointing towards the direction of the music application icon (1303). The electronic device (100) identifies that the user wants to perform the single-hand operation based on the UWB signal reflected from the hand. Further, the electronic device (100) determines the hand type, and the pointing direction of the thumb (1302). Further, the electronic device (100) identifies that the thumb (1302) is pointing towards the music application icon (1303) based on the determined direction. Further, the electronic device (100) determines the location on the screen (150) closer to the thumb (1302). At 1304, the electronic device (100) moves the music application icon (1303) closer to the thumb (1302) for ease of operation of the user, which enhances the user experience in the foldable smartphones and tablets. The proposed method provides more natural, unobtrusive, seamless interactions over existing single-mode operation.

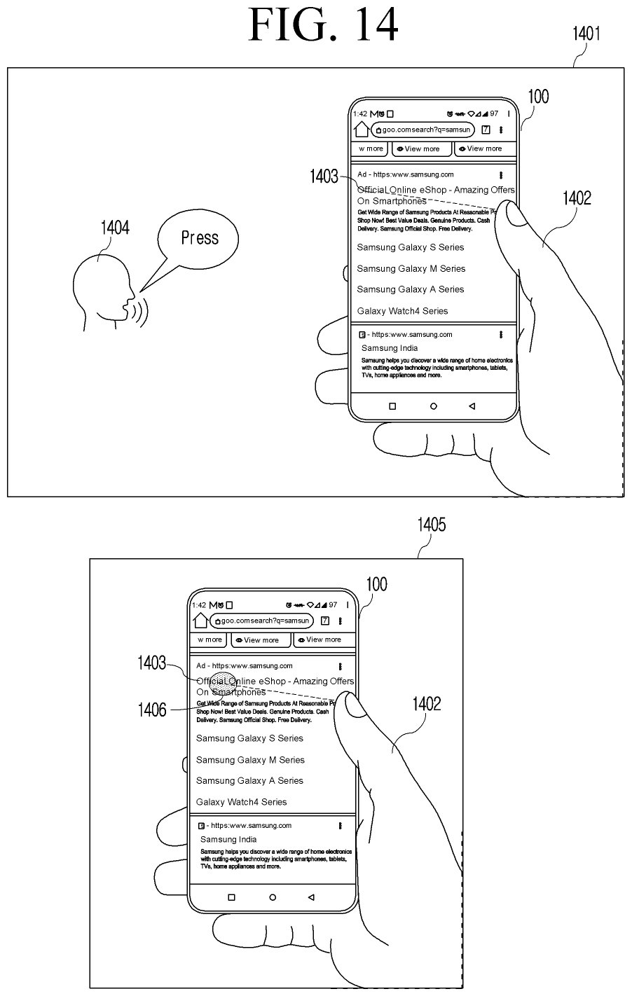

As shown in the FIG. 14, in another example scenario, consider the user is holding the electronic device (100) on the hand for performing the single-hand operation on a search result (1403) of a search engine at 1401. The thumb (1402) is pointing towards the direction of search result (1403). The electronic device (100) identifies that the user wants to perform the single-hand operation based on the UWB signal reflected from the hand. Further, the electronic device (100) determines the hand type, and the pointing direction of the thumb (1402). Further, the electronic device (100) identifies that the thumb (1402) is pointing towards the search result (1403) based on the determined direction. Further, the user provides the voice command (1404) like press or long-press or additional finger gestures to the electronic device (100). At 1405, upon receiving the voice command or the finger gestures, the electronic device (100) displays the pointer (1406) on the search result (1403), and performs an action on the search result (1403) such as opening a website linked to the search result (1403) or showing a quick preview of content linked to the search result (1403), for ease of operation of the user.

The embodiments disclosed herein can be implemented using at least one hardware device and performing network management functions to control the elements.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the embodiments as described herein.

What is claimed is:

1. A single-handed operation assistance method for an electronic device, comprising:
detecting, by the electronic device, a single-hand use state of the electronic device;
determining, by the electronic device, a location of a finger of a hand of a user relative to a location of at least one user interface (UI) element being displayed on a screen of the electronic device; and
altering, by the electronic device, a location of the at least one UI element to be closer to the finger based on the location of the finger of the hand of the user.

2. The method as claimed in claim 1, wherein the single-hand use state of the electronic device is detected using an Ultra-Wide Band (UWB) sensor of the electronic device.

3. The method as claimed in claim 1, wherein the method comprises automatically activating a single-handed operation assistance mode based on detecting the single-hand use state of the electronic device.

4. The method as claimed in claim 1, wherein the determining the location of the finger of the hand of the user relative to the location of the at least one UI element being displayed on the screen of the electronic device comprises:
receiving, by the electronic device, a UWB signal reflected off the finger;
estimating, by the electronic device, a type of the hand of the user by providing the reflected UWB signal to an AI model;
determining, by the electronic device, a direction of the finger pointing towards the at least one UI element based on the reflected UWB signal and the type of the hand;
identifying, by the electronic device, the at least one UI element being displayed on the screen based on the direction of the finger; and
determining, by the electronic device, the location of the finger of the hand relative to the location of the at least one UI element.

5. The method as claimed in claim 4, wherein the determining the direction of the finger pointing towards the at least one UI element comprises:
determining, by the electronic device, permittivity of one or more parts of the finger based on the reflected UWB signal;
identifying, by the electronic device, the one or more parts of the finger based on the permittivity;
determining, by the electronic device, proximity between the one or more parts of the finger based on the permittivity;
determining, by the electronic device, a projection of the finger relative to the electronic device based on the reflected UWB signal; and
determining, by the electronic device, the direction of the finger pointing towards the at least one UI element based on the one or more parts of the finger, the proximity between the one or more parts of the finger, and the projection of the finger.

6. The method as claimed in claim 1, wherein the altering the location of the at least one UI element closer to the finger comprises:
determining, by the electronic device, a location on the screen closer to the finger based on the location of the finger; and
altering, by the electronic device, the location of the at least one UI element to the location on the screen.

7. An electronic device for single-handed operation assistance, comprising:
memory;
at least one processor;
a screen;
an Ultra-Wide Band (UWB) sensor; and
a single-hand mode assistance engine, coupled to the memory and the at least one processor, configured for:
detecting a single-hand use state of the electronic device,
determining a location of a finger of a hand of a user relative to a location of at least one user interface (UI) element being displayed on the screen, and
altering a location of the at least one UI element to be closer to the finger after the alteration based on the location of the finger of the hand of the user.

8. The electronic device as claimed in claim 7, wherein the single-hand use state of the electronic device is detected using the UWB sensor.

9. The electronic device as claimed in claim 7, wherein the single-hand mode assistance engine is configured for automatically activating a single-handed operation assistance mode based on detecting the single-hand use state of the electronic device.

10. The electronic device as claimed in claim 7, wherein the determining the location of the finger of the hand of the user relative to the location of the at least one UI element being displayed on the screen of the electronic device, comprises:
receiving a UWB signal reflected from the finger;
estimating a type of the hand of the user by providing the reflected UWB signal to an AI model;
determining a direction of the finger pointing towards the at least one UI element based on the reflected UWB signal and the type of the hand;
identifying the at least one UI element being displayed on the screen based on the direction of the finger; and
determining the location of the finger of the hand relative to the location of the at least one UI element.

11. The electronic device as claimed in claim 10, wherein the determining the direction of the finger pointing towards the at least one UI element based on the reflected UWB signal and the type of the hand, comprises:
determining permittivity of one or more parts of the finger based on the reflected UWB signal;
identifying one or more parts of the finger based on the permittivity;
determining proximity between the one or more parts of the finger based on the permittivity;
determining a projection of the finger relative to the electronic device based on the reflected UWB signal; and
determining the direction of the finger pointing towards the at least one UI element based on the one or more parts of the finger, the proximity between the one or more parts of the finger, and the projection of the finger.

12. The electronic device (100) as claimed in claim 7, wherein the altering the location of the at least one UI element closer to the finger, comprises:
determining a location on the screen closer to the finger based on the location of the finger; and
altering the location of the at least one UI element to the location on the screen.
